(19) United States
(12) Patent Application Publication
(10) Pub. No.: US 2016/0233515 A1
(43) Pub. Date: Aug. 11, 2016

(54) ELECTRODE PLATE AND BATTERY INCLUDING THE SAME

(71) Applicant: Exa Energy Technology Co., Ltd., Taichung City (TW)

(72) Inventors: LUN-CHIEH HO, Taichung City (TW); YIH-SONG JAN, Taipei City (TW)

(21) Appl. No.: 15/017,301

(22) Filed: Feb. 5, 2016

(30) Foreign Application Priority Data
Feb. 6, 2015 (TW) 104201998

(51) Int. Cl. H01M 4/70; H01M 2/26

(52) U.S. Cl. CPC H01M 4/70; H01M 2/26

(57) ABSTRACT

An electrode plate adapted for being arranged in a battery includes a base plate and a conducting arm. The base plate is adapted for being arranged in a battery. The base plate is electrically conductive and has a first face and a second face. At least part of the second face is a coarse surface for connected with a shell of the battery. The conducting arm is integrally formed at a side of the base plate and is exposed outside the battery when the electrode plate is arranged in the battery.

### BACKGROUND OF THE INVENTION

1. Field of the Invention

The present invention relates to a battery, especially to an electrode plate of a battery.

2. Description of the Prior Art

Recently, batteries become much thinner to be available for thin-type electronic devices such as electronic credit card. A conventional electrode plate is formed from a cut base plate spread with anode or cathode activating layer. The base plate has to be preserved with some area without the activating layer for welding with the conducting arm. A typical one is shown in patent TW 481935.

However, preserving the area for welding results in that the area of the activating layer is reduced to have smaller battery capacity. Besides, the step of welding consumes much time and makes the battery thicker. In addition, the solder between the base plate and the conducting arm increases the resistance therebetween.

### SUMMARY OF THE INVENTION

The main object of the present invention is to provide an electrode plate and a battery having the electrode plate which are advantageous in thinning the battery, improving efficiency of electrical conduction, and increase battery capacity.

To achieve the above and other objects, an electrode plate is provided. The electrode plate is adapted for being arranged in a battery. The electrode plate includes a base plate and a conducting arm. The base plate is adapted for being received in the battery. The base plate is electrically conductive and has a first face and a second face. At least part of the second face is a coarse surface for connecting with a shell of the battery. The conducting arm is integrally formed on a side of the base plate and is protruded from the battery when the electrode plate is arranged in the battery.

To achieve the above and other objects, a battery is also provided. The battery includes two electrode plates mentioned above, an electrolysis layer, an anode activating layer, a cathode activating layer, and a shell. The anode activating layer is sandwiched between one side of the electrolysis layer and the base plate of one of the electrode plates, and the cathode activating layer is sandwiched between an opposite side of the electrolysis layer and the base plate of the other one of the electrode plates. The shell covers the two base plates, the electrolysis layer, the anode activating layer, and the cathode activating layer. Each of the conducting arms is exposed outside the battery.

Thereby, the integrally formed conducting arm and base plate can shorten the process of manufacturing and make the electrode plate thinner. Besides, without the solder between the conducting arm and the base plate, the resistance therebetween is reduced so as to improve the efficiency of electrical conduction. In addition, there is no necessary to reserve area of the base plate for welding, so the area of the activating layer can be increased so as to increase the battery capacity. Furthermore, the shell is easier to be adhered to the electrode plate due to the coarse surface.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIGS. 1 and 2 are stereograms of an electrode plate showing a first embodiment of the present invention;

FIGS. 3 and 4 are illustrations of the anode activating layer and the electrode plate showing a first embodiment of the present invention;

FIGS. 5 and 6 are illustrations of the cathode activating layer and the electrode plate showing a first embodiment of the present invention;

FIG. 7 is an illustration of a battery showing a first embodiment of the present invention;

FIG. 8 is a cross-section of a shell showing a first embodiment of the present invention;

FIG. 9 is a stereogram of a battery showing a first embodiment of the present invention;

FIG. 10 is a cross-section of a battery showing a first embodiment of the present invention;

FIG. 11 is a partial enlargement of FIG. 10;

FIG. 12 is a breakdown drawing of a battery showing a second embodiment of the present invention;

FIG. 13 is a stereogram of a battery showing a second embodiment of the present invention;

FIG. 14 is a cross-section of a battery showing a second embodiment of the present invention;

FIG. 15 is a partial enlargement of FIG. 14.

### DETAILED DESCRIPTION OF THE PREFERRED EMBODIMENTS

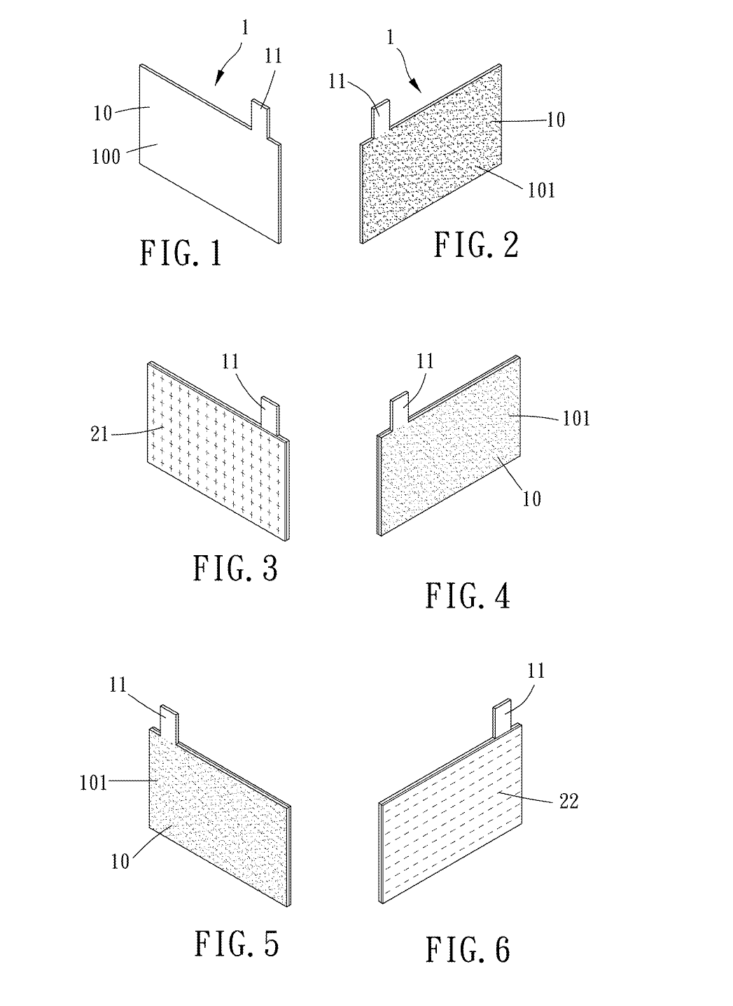

Please refer to FIG. 1 to FIG. 2 for a preferable embodiment of the present invention. The electrode plate 1 of the present invention is adapted for being arranged in a battery. The electrode plate 1 includes a base plate 10 and a conducting arm 11.

The base plate 10 is adapted for being arranged inside the battery. The base plate 10 is electrically conductive and has a first face 100 and a second face 101. Specifically, at least part of the second face 101 is a coarse surface for connecting with a shell of the battery. In the present embodiment, the whole second face 101 is the coarse surface to improve the adhesion between the base plate 10 and the shell. In practice, the coarse surface can be formed by electric corrosion. Alternatively, the coarse surface can be formed by scratching the second face 101 to form a plurality of grooves, or be formed by spreading a film having a plurality of bumps.

The base plate 10 is made of aluminum, copper, or stainless steel. More specifically, when the base plate 10 is used as an anode, the base plate 10 made of aluminum is preferable. When the base plate 10 is used as a cathode, the base plate 10 made of copper is preferable. Alternatively, the base plates 10 used as anode and cathode can be made both stainless steel. In other possible embodiments, the base plate can be made of other electrically conductive material.

The conducting arm 11 is integrally formed at a side of the base plate 10. Specifically, the base plate 10 and the conducting arm 11 are formed as a single piece by cutting. Preferably, the thickness of the base plate 10 is ranged between 18 micrometers to 22 micrometers. In the present embodiment, the thickness of the base plate 10 is 20 micrometers. Comparing with the thickness of 70 micrometers to 100 micrometers of the conventional base plate with conducting arm welding thereon, the base plate of the present embodiment is significantly thinner so that the electrode plate 1 of the present embodiment is advantageous in thinner batteries. When the electrode plate 1 is arranged in the battery, the conducting arm 11 is exposed outside the battery for conducting.

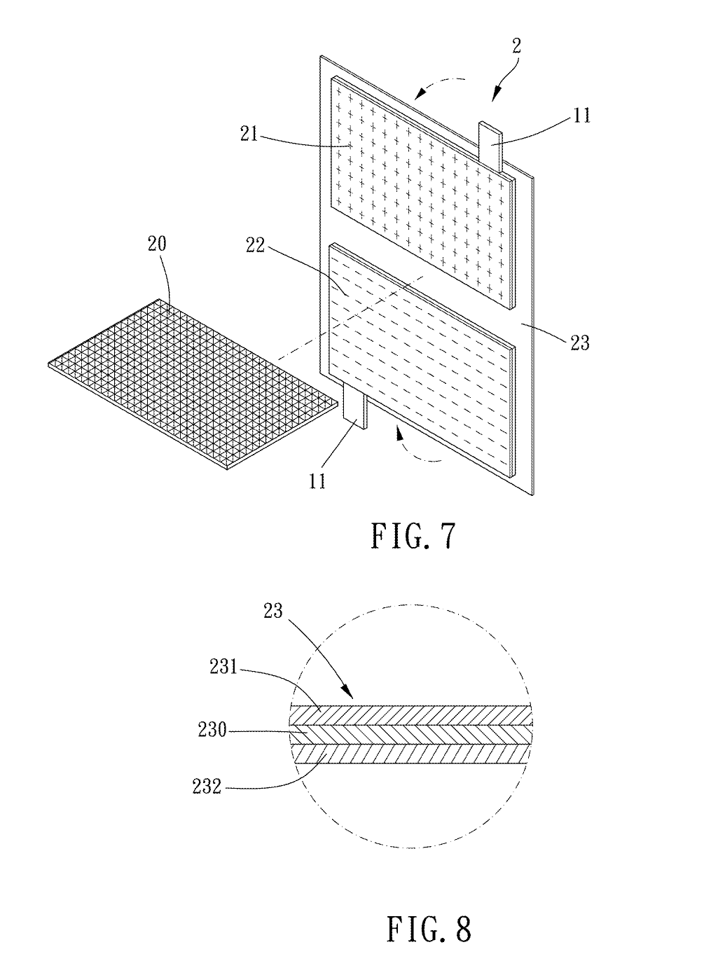

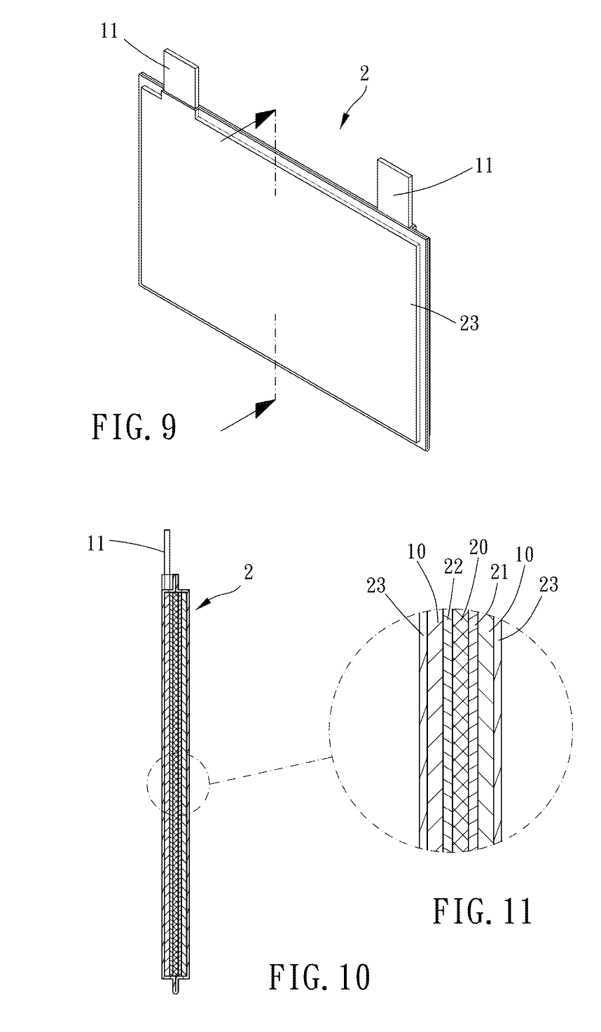

Please refer to FIGS. 3 to 11, a battery 2 is also provided. The battery 2 includes two electrode plates 1 shown in FIGS. 1 and 2 and further includes an electrolysis layer 20, an anode activating layer 21, a cathode activating layer 22, and a shell 23.

The anode activating layer 21 is sandwiched between one side of the electrolysis layer 20 and one of the base plates 10, and the cathode activating layer 22 is sandwiched between the other side of the electrolysis layer 20 and the other one base plate 10.

The shell 23 covers the two base plates 10, the electrolysis layer 20, the anode activating layer 21, and the cathode activating layer 22. The conducting arm 11 is exposed outside, at least partially. In the present embodiment, the shell 23 is made of composite material. The shell 23 includes an aluminum foil layer 230 and two first insulation layers 231. Each first insulation layer 231 is sandwiched between one of the base plates 10 and the aluminum foil layer 230. In this embodiment, the shell 23 further includes two second insulation layers 232. The second insulation layer 232 is disposed on two sides of the aluminum foil layer 230. Specifically, the first insulation layer 231 is made of thermoplastic plastic layer, such as polypropylene or polyethylene. When the battery is packaged by thermo compression, the thermoplastic plastics melts to facilitate the adhesion. The second insulation layer 232 is made of nylon to protect the battery.

In the process of manufacturing, the base plates 10 are fixed onto the shell 23 by thermo compression under a specific pressure and temperature. The coarse surfaces of the base plates 10 contact the shell 23, and at least part of each of the conducting arms 11 does not touch the shell 23. And then, the anode activating layer 21 and the cathode activating layer 22 are spread over the first faces 100 of the base plates 10. Alternatively, the activating layers are spread before the base plates 10 are fixed onto the shell 23. Thereafter, fold the shell 23 and insert the electrolysis layer 20 between the anode activating layer 21 and the cathode activating layer 22. Finally, package the fringes of the shell 23 by thermo compression.

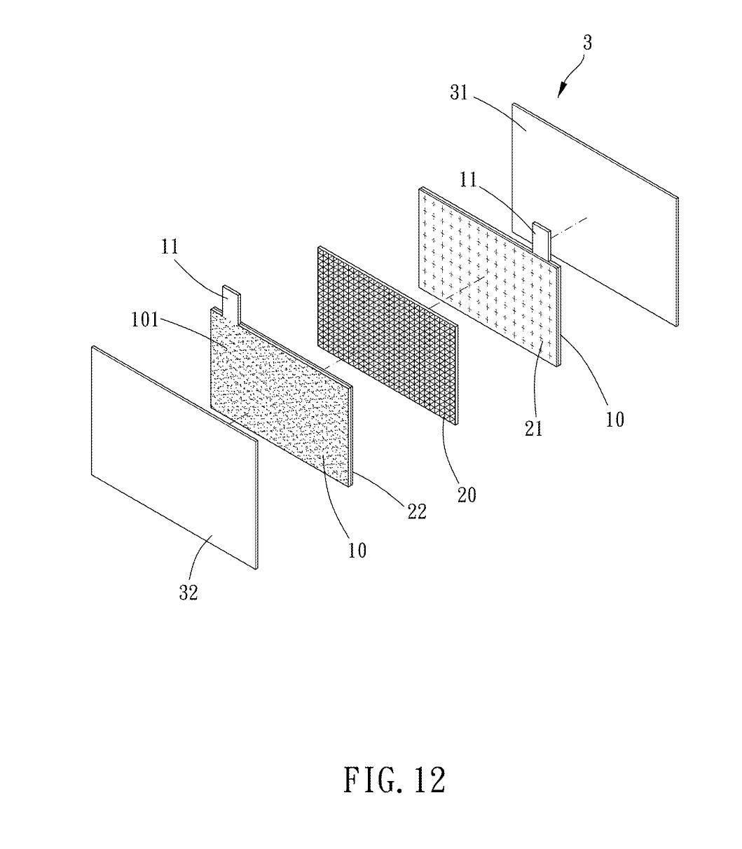

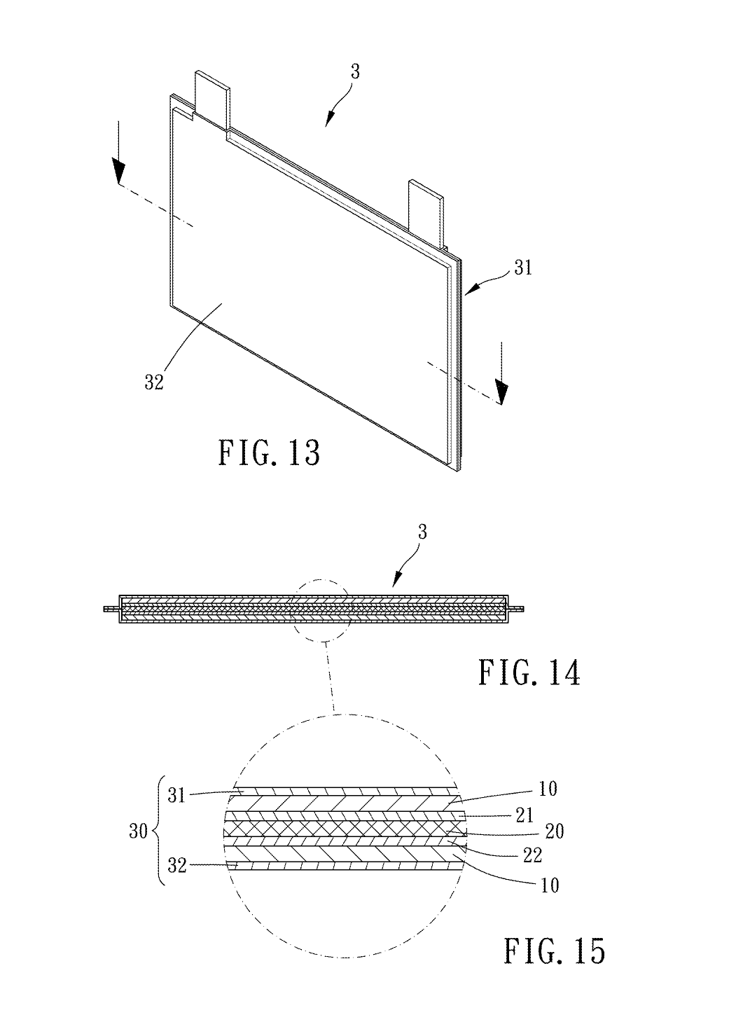

Another embodiment is shown in FIGS. 12 to 15. The shell 30 of the battery 3 includes a first shell member 31 and a second shell member 32 which are independent from each other. Thus, the step of folding is skipped. Fringes of the first shell member 31 and the second shell member 32 are packaged by thermo compression.

In conclusion, the electrode plate and the battery of the present invention have advantages listed below.
1. The conducting arm and the base plate are formed as a single piece by cutting, so the step of welding can be skipped. Thus, efficiency is improved, and the thickness is reduced.
2. The resistance between the conducting arm and the base plate is reduced.
3. There is no necessary to preserve any area of the base plate for welding, so the area for the activating layer can be increased so as to increase the battery capacity.
4. The coarse surface facilitates the adhesion between the electrode plate and the shell during thermo compression.

What is claimed is:

1. An electrode plate, adapted for being arranged in a battery, the electrode plate including:
a base plate, adapted for being received in the battery, being electrically conductive and having a first face and a second face, at least part of the second face being a coarse surface for connecting with a shell of the battery;
a conducting arm, integrally formed on a side of the base plate, being protruded from the battery when the electrode plate is arranged in the battery.

2. The electrode plate of claim 1, wherein the base plate is made of aluminum, copper, or stainless steel.

3. The electrode plate of claim 1, wherein the coarse surface has a plurality of pits of electric corrosion.

4. The electrode plate of claim 1, wherein the coarse surface has a plurality of grooves by scratching.

5. The electrode plate of claim 1, wherein the coarse surface has a plurality of bumps.

6. The electrode plate of claim 1, wherein the base plate has a thickness ranged from 18 micrometers to 22 micrometers.

7. A battery, including two the electrode plates of claim 1, further including:
an electrolysis layer;
an anode activating layer, sandwiched between a side of the electrolysis layer and the base plate of one of the electrode plates;
an cathode activating layer, sandwiched between an opposite side of the electrolysis layer and the base plate of the other one of the electrode plates;
a shell, covering the two base plates, the electrolysis layer, the anode activating layer, and the cathode activating layer, at least part of each conducting arm being exposed outside the shell.

8. The battery of claim 7, wherein the shell is integrally formed as a single piece.

9. The battery of claim 7, wherein the shell includes a first shell member and second shell member connected to each other with their fringes.

10. The battery of claim 7, wherein the shell includes an aluminum foil layer and two first insulation layers, the each first insulation layer is sandwiched between one of the base plates and the aluminum foil layer.
